(19) United States
(12) Patent Application Publication
(10) Pub. No.: US 2014/0074616 A1
(43) Pub. Date: Mar. 13, 2014

(54) SYSTEMS, METHODS, AND COMPUTER PROGRAM PRODUCTS FOR MANAGING SERVICE PROVIDER OFFERS

(71) Applicant: JVL VENTURES, LLC, New York, NY (US)

(72) Inventors: Kai P. Johnson, San Diego, CA (US); Todd A. Strickler, Rockville, MD (US); Robert C. Sprogis, Oak Hill, VA (US); Gordon C. Saussy, Potomac, MD (US)

(73) Assignee: JVL VENTURES, LLC, New York, NY (US)

(21) Appl. No.: 13/975,549

(22) Filed: Aug. 26, 2013

Related U.S. Application Data
(60) Provisional application No. 61/700,491, filed on Sep. 13, 2012.
(60) Provisional application No. 61/700,496, filed on Sep. 13, 2012.

(51) Int. Cl. G06Q 30/02

(52) U.S. Cl. CPC G06Q 30/0267
USPC 705/14.64

(57) ABSTRACT

Methods, systems and computer program products are provided for managing service provider offers. An offer associated with a service provider is generated and the offer includes attributes defining the offer. A campaign is selected to pair the offer to. The campaign includes criteria for receiving the offer. The offer is delivered to a mobile device associated with a consumer matching the campaign criteria, and is rendered at the mobile device.

### CROSS-REFERENCE TO RELATED APPLICATIONS

This application claims priority to U.S. Provisional Application No. 61/700,491, filed Sep. 13, 2012, and to U.S. Provisional Application No. 61/700,496, filed Sep. 13, 2012, the contents of which are incorporated herein by reference.

### BACKGROUND

I. Field

Example aspects of the present invention generally relate to managing service provider offers, and more particularly to generating offers to be delivered to a consumer device.

II. Related Art

Typically, merchants provide offers to consumers via channels such as physical mail or email. For example, a merchant might send a flyer including coupons for a particular good or service. In another example, a merchant might email an offer to consumers who have provided an email address to the merchant.

However, such traditional channels have limited effectiveness. For example, mass communications sent via physical mail or email tend to be overlooked or discarded by consumers, and thus do not reach the intended audience. In fact, such mass communications can have negative effects on a merchant's reputation. In addition, even if a consumer wishes to receive the offer, the redemption process is often inconvenient. For example, the consumer may have to search through email and print the offer or bring physical mail to the merchant's location.

### BRIEF DESCRIPTION

The example embodiments described herein address the above-identified needs by providing a methods, systems and computer program products for managing service provider offers. An offer associated with a service provider is generated, and the offer includes attributes defining the offer. A campaign is selected to pair the offer to. The campaign includes criteria for receiving the offer. The offer is delivered to a mobile device associated with a consumer matching the campaign criteria, and the offer is rendered at the mobile device.

### BRIEF DESCRIPTION OF THE DRAWINGS

The features and advantages of the example embodiments of the invention presented herein will become more apparent from the detailed description set forth below when taken in conjunction with the following drawings.

FIGS. 1A to 1C are representative views of a system in which some embodiments of the invention may be implemented.

FIG. 2 is a flowchart diagram illustrating an exemplary procedure for managing service provider offers.

FIG. 3 is a representative view for illustrating use cases for a partner according to an example embodiment.

FIG. 4 is a flowchart diagram illustrating an exemplary procedure for selecting offers to redeem.

FIG. 5 illustrates representative views for illustrating redemption of an offer in accordance with an example embodiment of the present invention.

FIG. 6 is a flowchart diagram illustrating an exemplary procedure for redeeming an offer.

FIG. 7 is a representative view of consumer interfaces presented to a consumer according to an example embodiment.

FIG. 8 is a block diagram of a device for use with various example embodiments of the invention.

### DETAILED DESCRIPTION

The example embodiments of the invention presented herein are directed to methods, systems and computer program products for managing service provider offers. This description is not intended to limit the application of the example embodiments presented herein. In fact, after reading the following description, it will be apparent to one skilled in the relevant art(s) how to implement the following example embodiments in alternative embodiments, such as such as a services-based environment, a web media-based environment, etc.

For simplicity, the system acting as the intermediary between partners (merchants) and consumers is referred to as a mobile commerce (MoCom) platform or MoCom system. Of course, the invention is not necessarily limited to mobile devices, and other designations are possible. In addition, while the construct for storing the user's MoCom information is referred to as a wallet application, it should be understood that other constructs are possible, including, for example, a loyalty program application, an application running on behalf of a merchant, and so on. Moreover, a merchant who generates offers may be referred to as a “service provider” or “partner”, depending on context.

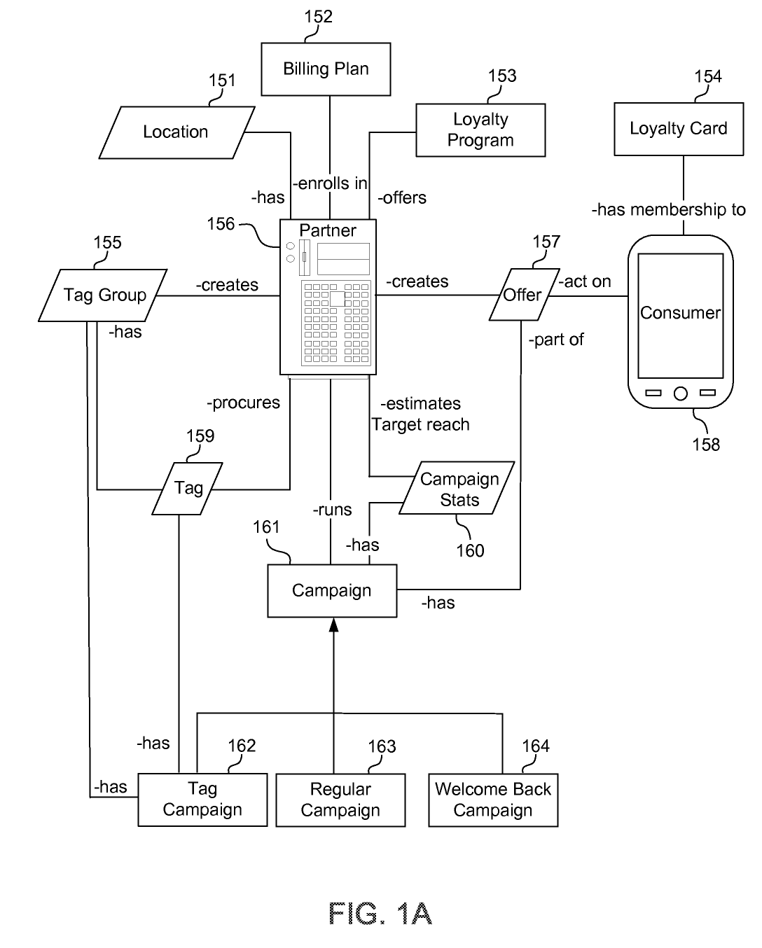

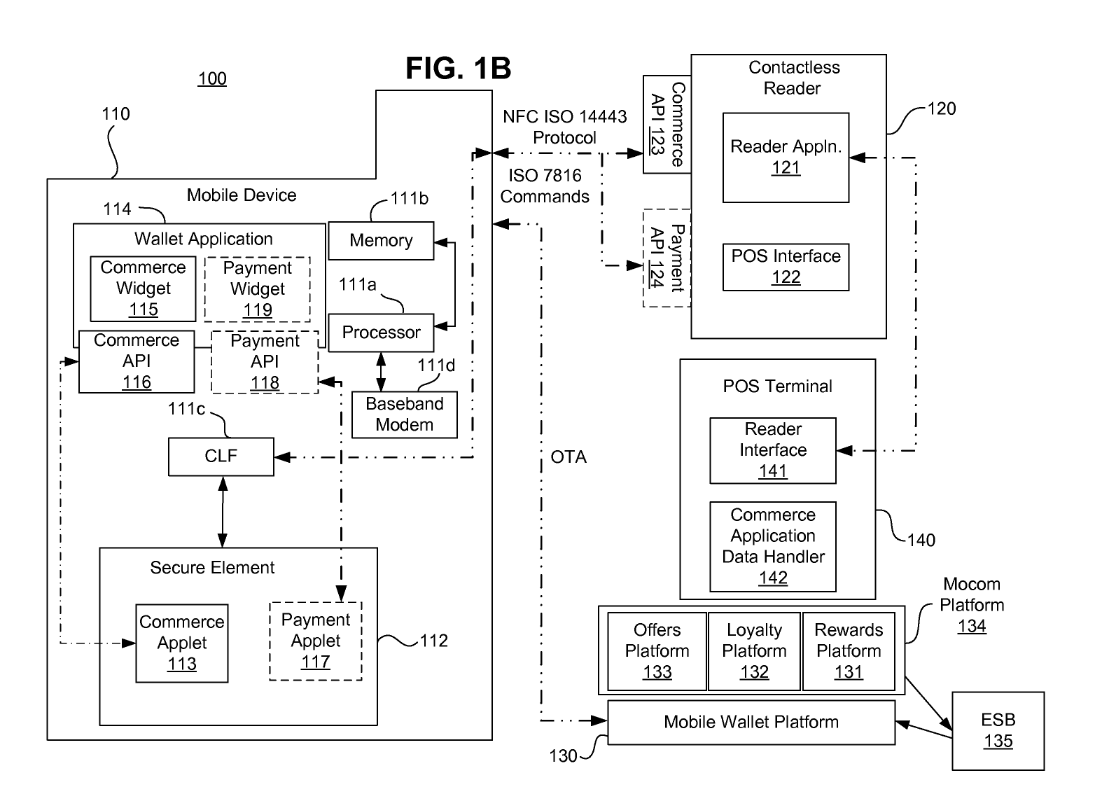

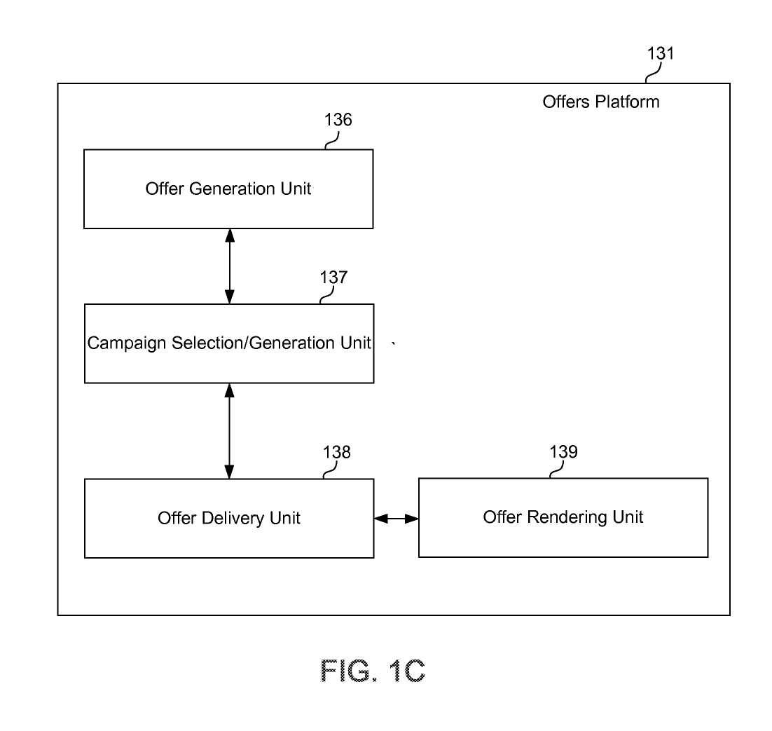

FIG. 1A is a representative view of a system in which some embodiments of the invention may be implemented.

In particular, FIG. 1A depicts an overall example of interactions between a consumers and partners facilitated by the MoCom platform according to an example embodiment.

Briefly, as shown in FIG. 1, partner system 156 (hereafter “partner 156) is a server computer or a system or network of computers operated by a partner entity. Partner 156 is operated by a service provider or merchant who provides goods or services to consumers. Consumer device 158 (hereafter “consumer 158”) is a mobile device or other computing device which is operated by customers of partner 158. Offer 157 is a data object which corresponds to a coupon, discount, or other benefit provided to consumer 158, ordinarily subject to terms and conditions (e.g., a 20% discount when a purchase exceeds $50.00). Tag 159 is a data object which may correspond to a visual object displayed on a mobile device or other computing device, and which may be tied to one or more offers. Campaign 161 is a procedure, algorithm or other program by which an offer is provided to consumers (sometimes referred to as an “offer program”. Each of these will be described more fully below.

Referring again to FIG. 1A, partner 156 runs campaign 161. A campaign 161 is an offer program which is provided to consumers. In particular, campaign 161 has offer 157, which is provided to consumer 158.

Partner 156 creates an offer 157 as part of campaign 161. According to one example embodiment, partner 156 may be, for example, a retail or online merchant, who creates offer 157 for consumer 158 to act on. Partner 156 has location 151, which in some embodiments might be incorporated into the conditions of the offer, e.g., only providing the offer to consumers within a certain range near partner location 151. Partner 156 enrolls in a billing plan 152 according to an example embodiment, to pay for services included in presenting offers to consumers. Partner 156 also offers loyalty program 153 to consumer 158. In that regard, loyalty program 153 may include, for example, a membership card or number corresponding to the partner, by which a consumer receives discounts and offers associated with partner 156.

As explained above, campaign 161 is an offer program that has offer 157, which is provided to consumers. In other words, campaign 161 is the vehicle by which offers are presented to a consumer. According to one example embodiment, an offer must be tied to a campaign, and the campaign conditions/attributes determine which consumers receive the offer, and under what circumstances. Campaign 161 may comprise, for example, a tag campaign 162 which includes visible tags to be displayed on a device of consumer 158. For example, tag campaign 162 may include tag 159, which has a tag group 155. In this example, partner 156 creates tag group 155, and procures tag(s) 130 as selectable icons corresponding to the offer. Campaign 161 may also comprise a “regular” campaign 163, which can correspond to, for example, a coupon offer or loyalty program offer (e.g., 20% off all purchases over $500) which is not tied to a particular tag. Campaign 161 may also comprise a welcome back campaign 164, which is based on a consumer's usage of a loyalty program after a prolonged absence, or which may also be offered to consumers new to the loyalty program. Campaign 161 has campaign statistics 160, which may be estimated by partner 156 to determine, for example, the reach and/or cost of campaign 161.

Consumer 158 acts on offer 157. In particular, consumer 158 is targeted as part of campaign 161 and may receive offer 157 via, for example, a mobile device, as discussed more fully below. In some aspects, offer 157 is analogous to a coupon. Generally, consumer 158 has some sort of loyalty card 154 corresponding to partner 156, so that the consumer can receive discounts and/or offers from partner 156. In that regard, loyalty card 154 does not necessarily need to be a physical card, and can instead simply correspond to data indicating a relationship between consumer 158 and partner 156.

FIG. 1B is a graphical representation of a MoCom platform architecture in accordance with an exemplary embodiment. As shown in FIG. 1B, system 100 includes a mobile device 110 communicatively coupled to a contactless (e.g., proximity or NFC) reader 120 and a mobile wallet platform 130. Reader 120 also is communicatively coupled to a POS terminal 140. POS terminal 140 may be within the same housing as reader 120. Alternatively, POS terminal 140 and reader 120 are communicatively coupled with each other but each of these components is housed separately.

Mobile device 110 may be, for example, a cellular phone or the like, and includes a processor 111a, memory 111b, a contactless frontend (CLF) 111c, a baseband modem 111d, and a user interface such as a display (not shown). Baseband modem 111d is a digital modem that is used for mobile network communications. CLF 111c is circuitry which handles the analog aspect of contactless or NFC communications and the communication protocol layers of a contactless transmission link. CLF 111c also is used to exchange data between reader 120 and a secure element (or SE) 112 contained in mobile device 110, for example, to execute contactless transactions.

Secure element 112 may be implemented as a Universal Integrated Circuit Card (UICC), embedded SE card, secure micro secure digital (microSD) card, and the like. Secure element 112 is generally considered secure because it is a self-contained system, including dedicated memory, and is protected by hardware and software hardening techniques that are verified by independent testing.

Secure element 112 includes (e.g., stored thereon) one or more commerce applets 113. A commerce applet 113 may be associated with one or more commerce services and/or accounts issued by a commerce service provider (SP). A service provider is a company, organization, entity, or the like, that provides services to customers or consumers. Examples of service providers include account-issuing entities such as banks, merchants, card associations, marketing companies, and transit authorities. A service may be an activity, capability, functionality, work, or use that is permitted or provided by a service provider, such as a payment service, credit, debit, checking, gift, offer or loyalty service, transit pass service, and the like.

A commerce service provider can utilize one or more commerce applets 113 in a contactless transaction. Other service providers can utilize the same or other commerce applets 113 on the secure element 112. Generally, a commerce applet 113 can be instantiated and personalized with data related to loyalty and offers, thereby providing an APDU interface through which this data can be managed to conduct a contactless transaction. Commerce applet 113 operates as a generic storage container, allowing multiple loyalty/offer services to share mechanisms (e.g., secure element, mobile device) for loyalty and/or offer data management, for example, by instantiating and personalizing a commerce applet which, in turn, is used by a commerce service provider to execute a contactless transaction. If memory restrictions and performance requirements limit the amount of loyalty/offers data that can be stored on secure element 112, additional data can be stored in mobile device memory 111b and managed by the consumer via commerce widget 115. For example, any graphic images related to an offer can be stored in memory 111b in order to optimize secure element memory allocation. Loyalty/offers data management can be handled by the corresponding offer platform 131, loyalty platform 132, or rewards platform 133.

Commerce applet 113 may include a cached merchant data table enabling the storage and/or management of data related to one or more merchants. This table allows the commerce data for one or more merchants to be loaded within the secure element 112 or mobile device 110 by a wallet application, thereby providing efficient access to and querying of the stored data to perform transactions. This data may be stored in a record oriented data buffer. In an exemplary embodiment, a merchant identifier is used as the key field for search/retrieval tasks. Optionally, an index (or hash table) may be created to improve performance.

A commerce applet 113 (or, alternatively, multiple commerce applets 113) can be loaded onto the secure element 112, for example, during manufacture and/or configuration of the secure element 112 and may, in turn, be instantiated and personalized to enable its use to conduct commerce transactions. A table can be used to store merchant and/or consumer data for use in a commerce transaction. Such merchant and/or consumer data may include, but is not limited to, a merchant's store address, store phone number, store contact name, store contact phone number, store contact email address, store fax number, a number of check-out lanes, payment terminal manufacturer(s), payment terminal model number(s), whether contactless transactions are employed at the store location, payment terminal parameters or ECR parameters, and the store location. A commerce applet 113 interfaces with reader 120 via a commerce application programming interface (API) 123. In an exemplary embodiment, a commerce applet 113 is in the form of a JavaCard applet and is accessible through the use of APDU commands as defined in ISO 7816-4. Particularly, commerce applet 113 communicates commerce elements to reader 120 via secure element 112 using ISO 7816 commands over the NFC ISO 14443 protocol.

Secure element 112 can also include one or more payment applets 117 where each payment applet 117 is associated with a payment service and an account issued by a payment service provider. One or more payment applets 117 also can be loaded onto the secure element 112, for example, during manufacture and/or configuration of the secure element 112, and may be personalized to enable its use to conduct payment transactions. A payment applet 117 interfaces with reader 120 via API 124. In an exemplary embodiment, payment applet 117 is in the form of a JavaCard applet and is accessible through the use of APDU commands as defined in ISO 7816-4. Payment applet 113 also communicates payment elements to reader 120 via secure element 112 using ISO 7816 commands over the NFC ISO 14443 protocol.

It should be understood that other communications between the aforementioned devices may include communications with or through other intervening systems, hardware, and/or software, and such communications may include receiving, transferring, and/or managing data.

A wallet application 114 stored on mobile device 110 includes instructions which, when executed by the processor of the mobile device 110, cause the mobile device 110 to act as an instrument, for example, for processing transactions such as contactless commerce and/or payment transactions. Wallet application 114 communicates, through the use of APDU commands as defined in ISO 7816-4, with the commerce applet 113 via commerce API 116 and to payment applet 117 via payment API 118.

Commerce widget 115 is a component of the wallet application 114 that provides an interface for consumers to manage commerce elements (e.g., loyalty card credentials, offers and rewards), for example, through interactions with the display or user interface of a mobile device. Commerce widget 115 maintains, for example, a master list of commerce elements present on the handset in a memory of the mobile device (e.g., 111b). A subset of offers that have been identified as ready to be used are, in turn, moved to secure element 112 to be communicated to contactless reader 120 and POS terminal 140. Sensitive information, such as loyalty account identifiers can be stored on secure element 112.

Payment widget 119 is a component of the wallet application 114 that provides an interface for consumers to manage payment elements (e.g., credit or debit card credentials), for example, through interactions with the display or user interface of a mobile device.

Reader 120 includes a reader commerce application 121 (referred to herein simply as a “reader application”) and a POS interface 122. Reader 120 manages two interfaces: one interface is with the secure element 112 in the mobile device 110 and the other interface is with POS terminal 140 which includes a reader interface 141 and a commerce application data handler 142. The functionality of reader 120 is the same whether reader 120 is standalone and connected to a payments terminal or merchant POS, or is integrated therein. Contactless payment functionality is also contained in reader 120 but is not shown.

Mobile device 110 is further communicatively coupled to a mobile wallet platform 130, which in turn is communicatively coupled to offers platform 131, loyalty platform 132 and rewards platform 133. Collectively, offers platform 131, loyalty platform 132 and rewards platform 133 can be referred to as a mobile commerce (MoCom) platform 134 and are implemented on one or more servers, referred to herein individually and collectively as a MoCom server. Meanwhile, MoCom platform 134 and mobile wallet platform 130 interact via Enterprise Service Bus (ESB) 135 which acts as an intermediary between the mobile wallet platform 130 and external party systems.

In one embodiment, a customer may use mobile device 110 to conduct a contactless transaction at a POS equipped with reader 120. The customer places the mobile device 110 within a predetermined required proximity of the contactless reader 120 (i.e., taps) causing CLF 111c of the mobile device 110 to communicate with reader 120 using, for example, NFC ISO 14443 protocols. Reader 120 also communicates with wallet application 114, commerce applet 113, and/or payment applications on the mobile device 110 to execute contactless transactions, such as redeeming an offer.

A secure element employs a Proximity Payment System Environment (PPSE) that serves as a directory of available credentials currently stored in secure element 112. Each credential is assigned a corresponding application identifier (AID) associated with a payment application and stored in the PPSE. When an NFC enabled-mobile device containing secure element 112 is placed in the vicinity of an NFC-enabled contactless reader, the contactless reader reads the credential and completes the transaction. Before doing so, however, the reader is initialized.

On mobile device 110, PPSE is an application used to maintain a list of payment applications stored on secure element 112, and provides accessibility to each payment application stored on the mobile device 112 by making them visible or not visible (i.e., accessible) to systems or devices.

Additional details of facilitating a transaction between a consumer, a partner and the MoCom system can be found in exemplary embodiments described in U.S. application Ser. No. 13/901,134 and U.S. application Ser. No. 13/901,188, both filed on May 23, 2013 and both entitled “Systems, Methods and Computer Program Products for Providing a Contactless Protocol”, and incorporated herein by reference in their entirety.

FIG. 1C is a block diagram for explaining further aspects of offer platform 131.

In particular, as shown in FIG. 1C, offers platform includes offer generation unit 136, campaign selection/generation unit 137, offer delivery unit 138, and offer rendering unit 139. Offer generation unit 136 generates an offer from a service provider including attributes defining the offer. Campaign selection/generation unit 137 selects a campaign to pair the offer to. Offer delivery unit 138 delivers the offer to a mobile device associated with a consumer matching the campaign. Offer rendering unit 139 enables rendering of the offer at the consumer's mobile device. Each of these processes is described more fully below.

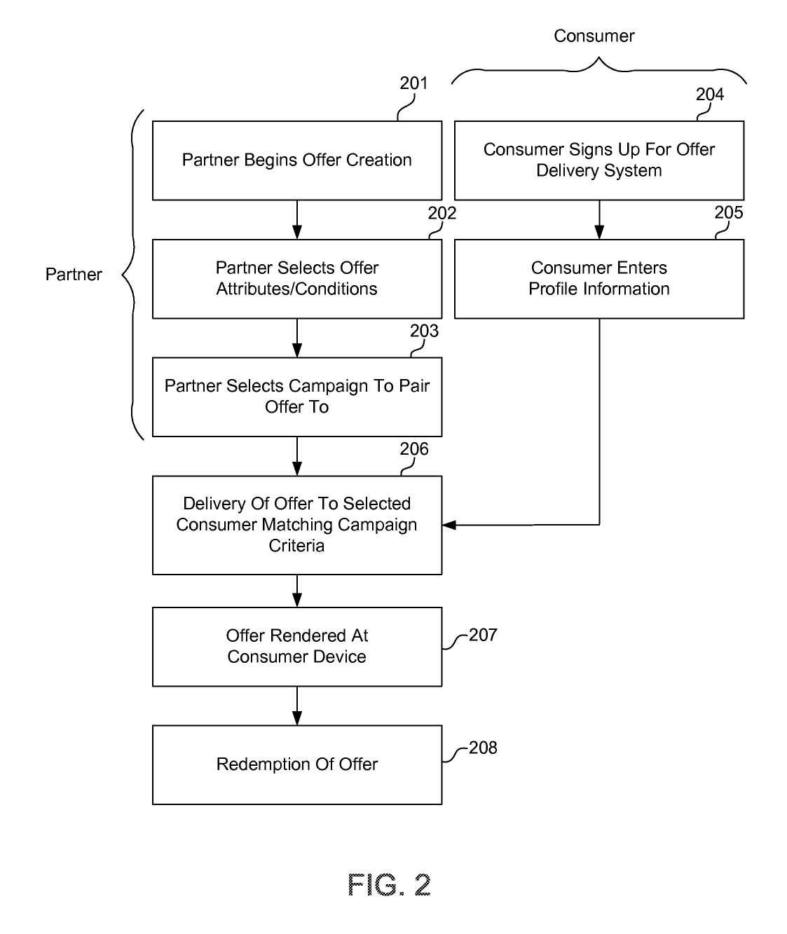

FIG. 2 is flowchart diagram illustrating an exemplary procedure for managing service provider offers.

Briefly, in FIG. 2, service provider offers are managed. An offer associated with a service provider is generated, and the offer includes attributes defining the offer. A campaign is selected to pair the offer to. The campaign includes criteria for receiving the offer. The offer is delivered to a mobile device associated with a consumer matching the campaign criteria, and is rendered at the mobile device.

In more detail, in step 201, a partner (e.g., a merchant) begins offer creation. In particular, a partner may access a website or other communication to request creation of an new offer, and may be provided with a consumer interface by which to create and update the offer. In some examples, the MoCom platform provides an application program interface (API) by which the service provider enters attributes of the offer and pairs the offer to the campaign.

In step 202, the partner selects offer attributes and/or conditions. The partner may select, for example, a logo, a description, a name, an offer code, an expiration date (both to the usage of the offer and to the visibility of the offer to a consumer, such that the offer expires after a predetermined period of time), whether the offer is distributed only to new consumers, the format by which the offer will be distributed (e.g., phone vs. web), terms and conditions of the offer (“fine print”), and so on.

In step 203, the partner selects a campaign to pair the offer to. In particular, according to example embodiments, a campaign serves as a distribution channel for offers created by the partner. The campaign may have its own attributes. For example, a partner may create a campaign via the user interface, and select, for the campaign, a set of one or more offers to be distributed for a set period of time, e.g., two weeks. The partner may define further distribution criteria for the campaign, such as, for example, zip codes of consumers to send the offer to. Other demographics of the campaign may include sending the offers of the campaign only to those consumers with loyalty cards (determined from consumer profile information discussed below), or only those consumers who have “liked” the partner or certain products via social media channels. The partner may also select, for example, whether the campaign is a “push” campaign to be sent to consumers, or a “click”/“pull” campaign which requires the consumer to actively inquire as to offers of that merchant.

According to the selections for the offer and the campaign, the offer can be generated and sent to the consumer, as discussed more fully below. As mentioned above, consumers only get offers if the consumer matches the criteria for an active campaign. Whether the consumer matches the campaign, in turn, can be determined from profile information of the consumer.

Thus, at the consumer end, in step 204, a consumer signs up for an offer delivery system. Specifically, a consumer enrolls in the MoCom system in order to receive offers from merchants. In one example, a consumer may be provided with a directory of merchants by the MoCom system, and may add loyalty cards for selected merchants. Thus, the MoCom system stores a directory of service providers, and a display of the service providers is provided at the consumer device to facilitate applying the offer to an existing transaction. As discussed above, the “card” need not be a physical card. Additionally, the loyalty card need not be a requirement for receiving offers, depending on the aspects of the campaigns provided by the partners.

In step 205, the consumer enters profile information into the MoCom platform, which can then be searched by the MoCom system to determine whether the consumer's profile matches a campaign. In particular, the consumer may enter, for example, a location, an age, loyalty cards, mobile device information, and the like, which can then be searched for a match. In another example, the consumer may enter preferences for products or services or partners. Thus, the consumer submits profile information to access to the MoCom system, and the MoCom system delivers offers from service providers corresponding to the submitted profile information. In that regard, the profile information can also include or be comprised of, for example, account information associated with the profile, or account information of a loyalty card or other account information corresponding to the consumer.

Thus, in step 206, the offer is delivered to selected consumer(s) matching campaign criteria. For example, the MoCom system may query consumer profiles to determine if there are any consumers which match the campaign criteria, as well as, for example, verifying that the offer has not expired. In one example, the campaign criteria include whether the consumer has previously indicated a preference for the service provider, as described above. Thus, there is a determination of whether a consumer matches the campaign criteria is made by comparing the campaign criteria against profile information of the consumer.

The MoCom platform can then deliver the offer created by the partner to the consumer. Alternatively, the MoCom platform may simply inform the partner of matching consumers, and the partner may deliver the offer directly to the consumer, for example by sending the offer electronically to the consumer's mobile device.

In step 207, the offer is rendered at the consumer device. For example, the offer may be sent to the consumer's mobile device as a downloadable coupon which can be displayed and redeemed at a merchant location, as discussed more fully below.

In step 208, the consumer redeems the offer in order to obtain the benefits of the offer. For example, an agent or reader at a merchant location may redeem the offer by scanning the coupon on the consumer's mobile device, as also discussed more fully below.

Details of managing the offers are shown in Appendix A. For example, section 1.1 describes an offer states service which can be used by a MoCom platform (or server) to collect, retrieve and/or store information related to activities and events. The MoCom platform can request event records and or activities (e.g., from the mobile device), and can store that information and any other information related to the transaction. Moreover, the offer states service enables clients' (e.g., consumers') handsets (e.g., mobile devices) to transmit event records to a MoCom platform, even when no connectivity is available. That is, a mobile device may transmit event records data and the like to the MoCom platform, either in response to a request from the MoCom platform or without being solicited by the MoCom platform (or any other system). The offer states service can store activities and events, and can bundle and transmit activity events to the MoCom platform, unsolicited or upon request.

As shown in section 1.1, the service can store a consumer identifier identifying the user, a wallet identifier, and a list of offer events including, as shown in section 1.1.2.1, an offer timestamp and one or more event actions such as redemption or deactivation, as listed in section 1.1.2.2. Additionally, as shown in section 1.1.3, a response code and/or message can be managed by the offer states service.

Meanwhile, Section 1.2 of Appendix A lists attributes and events managed by a get available offers service, which retrieves all available offers for the requesting consumer. Thus, for example, in response to a tap on the handset, the service description service may return offers including attributes such as a partner identifier, terms and conditions, and a barcode format, among many others.

Section 1.3 refers to a compute tag content service allowing a user to request tag offers and associated attributes, for a specific merchant and tag. Attributes of the merchant-specific tag may be similar to the attributes for other offers.

Section 1.4 of Appendix A lists elements of a restore offers service, which is provided by the MoCom platform and enables consumers to restore MoCom content back to the consumer's handset (e.g., mobile device). Barcode services enable clients to retrieve an industry standard barcode image such as a barcode corresponding to, for example, a redeemed offer.

Still referring to Appendix A, Section 2 illustrates examples of a customer profile management service, which allows a user to send customer profile content to the MoCom server, for example as discussed above with respect to steps 204 and 205. As shown throughout Section 2.1, a user submits a request and with a consumer identifier, a wallet identifier and customer profile events (Section 2.1.2.1) including, for example, last name, first name, city and state. The consumer can also send consumer preference related events (Section 2.2.1 to 2.2.3), such as whether a user prefers a particular merchant. Loyalty information can also be managed by a loyalty information service (section 2.3), and can send loyalty events such as a purchase or a loyalty card number to a MoCom server. A sync contactless transactions service (Section 2.4) enables consumers to send “contactless” events (e.g., by positioning the mobile device near a reader terminal) to the MoCom server, including transactions associated with a particular offer or loyalty card program.

Referring again to Appendix A, Sections 2.5 to 2.10 list services and attributes of the MoCom engine which are managed for the partner merchant. Thus, Sections 2.5 to 2.10 describe aspects of data objects which are managed as described in steps 201 to 203 of FIG. 2. For example, a merchant/partner can choose to create a regular offer (Section 2.5) with attributes such as a partner identifier, program start date/time, and program target criteria such as city, state, and the like. Alternatively, or in addition, a partner can create a welcome offer (Section 2.6) for consumers new to, for example, a loyalty program of the merchant. The partner can also submit a tag offer program with a tappable tag. (Section 2.7). Additionally, the partner can estimate offer program target statistics, i.e., submit target criteria and receive a count of MoCom consumers that can potentially receive offers for such criteria (Section 2.8), can query existing offer programs to retrieve partner program lists and

associated offers and attributes (Section 2.9), and can query offer program statistics to retrieve basic program statistics for an offer for a time range specified (Section 2.10).

Still in Appendix A, Section 3 is directed to offer management, and in particular how offers can be created and managed at the partner end along with, for example, corresponding images, such as described above in steps 201 to 203. For example, offers can be created as described above or with additional images (Section 3.1), but can also be updated (Section 3.2), deleted (Section 3.3), and queried (Section 3.4).

Section 4 refers to a service of the MoCom platform by which partners can submit a new tag (e.g., an image identifying the merchant and/or offer) to the MoCom platform, for forwarding to a consumer. For example, the partner can add a tag (Section 4.1), remove a tag (Section 4.2), or query tags (Section 4.3).

Section 5 describes a service for tag group management, by which a partner can create tag groups of multiple tags. Thus, for example, a partner can create a tag group (Section 5.1), update the tag group (Section 5.2), delete a tag group (Section 5.3), or query a tag group (Section 5.4).

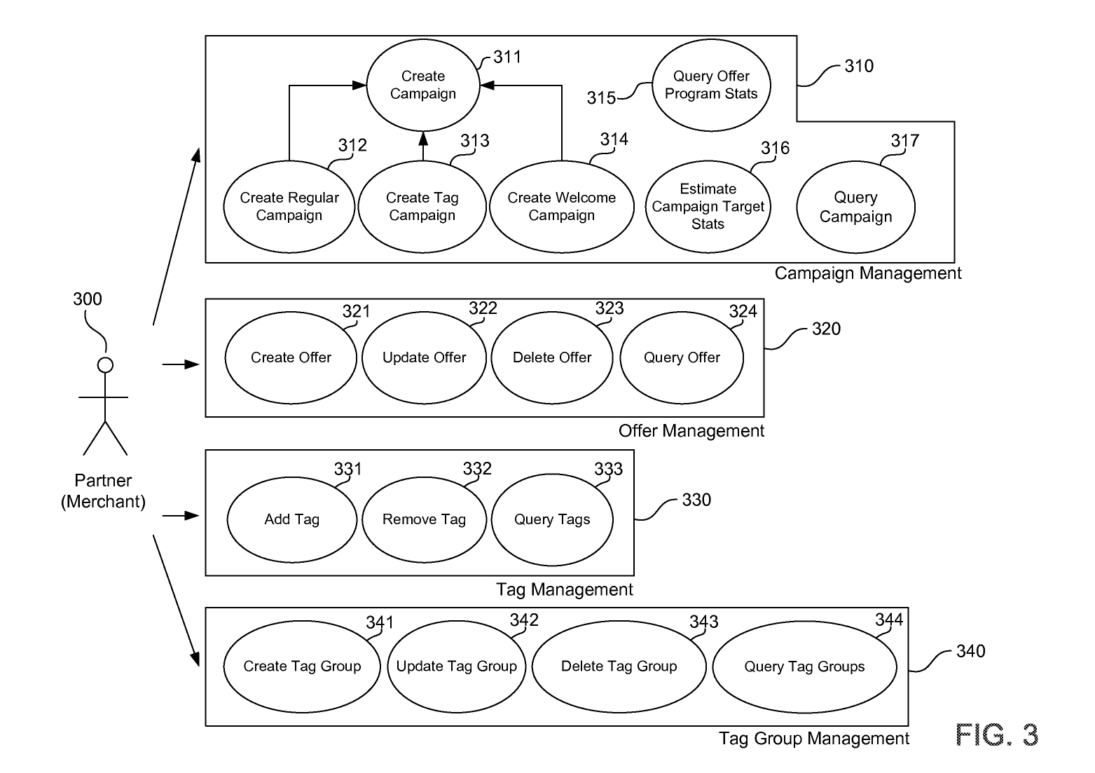

FIG. 3 is a representative view for illustrating use cases for a partner according to an example embodiment.

In particular, as shown in FIG. 3, use cases for the partner (e.g., a merchant) 300 generally fall into campaign management 310, offer management 320, tag management 330, and tag group management 340.

Block 310 illustrates campaign management use cases. As shown, the partner 300 (e.g., a merchant) has several use cases for the present invention. For example, the partner can create a campaign 311, which includes, for example, creating a regular campaign 312, creating a tag campaign 313, and/or creating a welcome campaign 314. Meanwhile, the partner 300 can also query offer program stats 315, in order to obtain information about a currently running campaign, such as the number of consumers who have redeemed a coupon corresponding to the campaign. Along the same lines, the partner 300 may estimate campaign target stats 316 in order to, for example, determine whether a campaign is going to meet projected goals. The partner 300 can also query the campaign in use case 317 in order to, for example, obtain a specific piece of information or search for specific information outside the context of general statistics.

Meanwhile, offer management 320 provides the partner 300 with the ability to create an offer 321, update the offer 322, delete the offer 323, or query the offer 324. Thus, partner 300 can more specifically create/update/query an existing offer, which may exist with several other offers in a campaign. Thus, for example, partner 300 can create a new offer to join an existing campaign, or can query a specific offer in an existing campaign to see whether that offer is meeting projected goals.

Tag management 330 provides partner 300 with the ability to create and manage a tag to be associated with partner 300 in the MoCom platform. A tag can correspond to, for example, a symbol or image corresponding to partner 300 which can be tapped, pointed to, or otherwise selected on a consumer device such as a cellular telephone. According to tag management 330, partner 300 can add a new tag 331, remove a tag 332, or query tags 333.

Tag group management 340 provides management of tags on a group basis. For example, tag groups may be managed as part of a set of campaigns provided by partner 300, or if partner 300 wants to present multiple selectable views to a consumer, e.g., for different offers within a campaign. Thus, as shown in FIG. 3, partner 300 can create a tag group 341, update a tag group 342, delete a tag group 343 or query tag groups 344.

Appendix B describes aspects of the use cases of FIG. 3 for the partner/merchant in more detail, including specific and alternative flows for each use case. Thus, for example, a partner can invoke the MoCom Merchant API, create an offer program (regular, welcome or tag offer), estimate offer program target statistics, query one or more offer programs or program statistics, update or delete offers, add, remove, or query tags, and create and manage tag groups.

The correspondence between these tasks and the corresponding use case information in Appendix B is shown in the table below:

| Primary | | |
|---|---|---|
| Actor | Use Case Group | Use Cases |
| Partner | Program | A1 - Create Offer Program |
| (merchant) | Management | A2 - Create Regular Offer Program |
| System | | A3 - Create Welcome Offer Program |
| | | A4 - Create Tag Offer Program |
| | | A5 - Estimate Offer Program Target Stats |
| | | A6 - Query Offer Programs |
| | | A7 - Query Offer Program Stats |
| | Offer | B1 - Create Offer |
| | Management | B2 - Update Offer |
| | | B3 - Delete Offer |
| | | B4 - Query Offers |
| | Tag Management | C1 - Add Tag |
| | | C2 - Remove Tag |
| | | C3 - Query Tags |
| | Tag Group | D1 - Create Tag Group |
| | Management | D2 - Edit Tag Group |
| | | D3 - Delete Tag Group |
| | | D4 - Query Tag Groups |

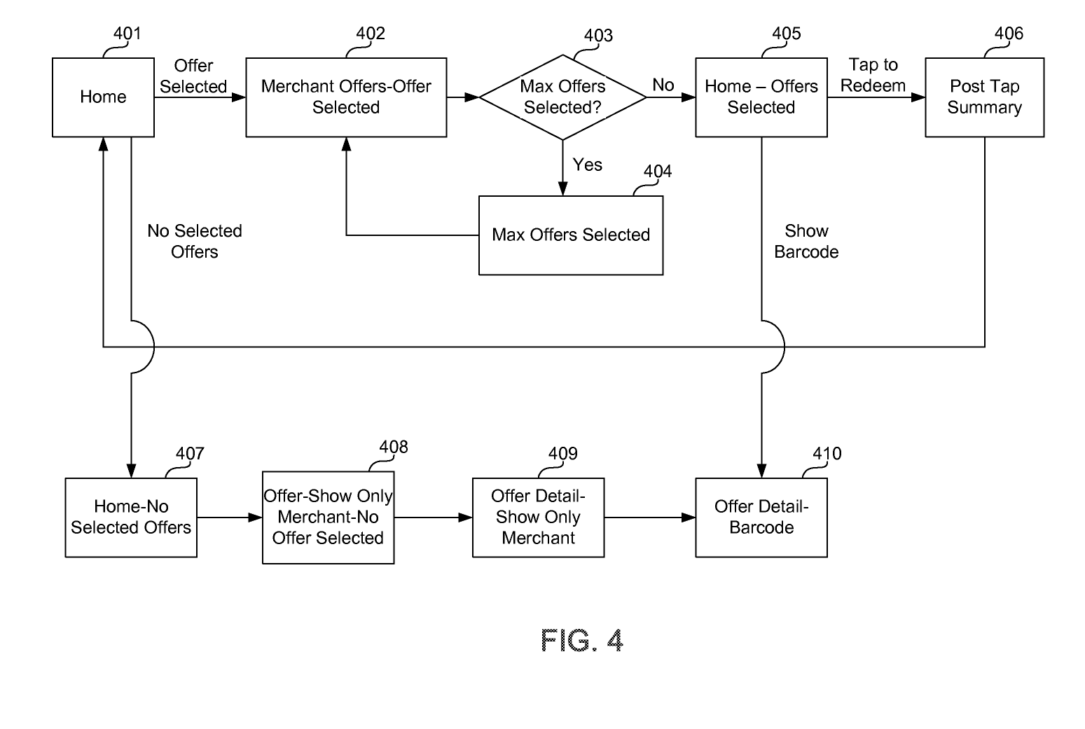

FIG. 4 is a flowchart diagram illustrating an exemplary procedure for selecting offers to redeem.

In particular, FIG. 4 depicts an example flow for a consumer to select and redeem an offer provided by a partner.

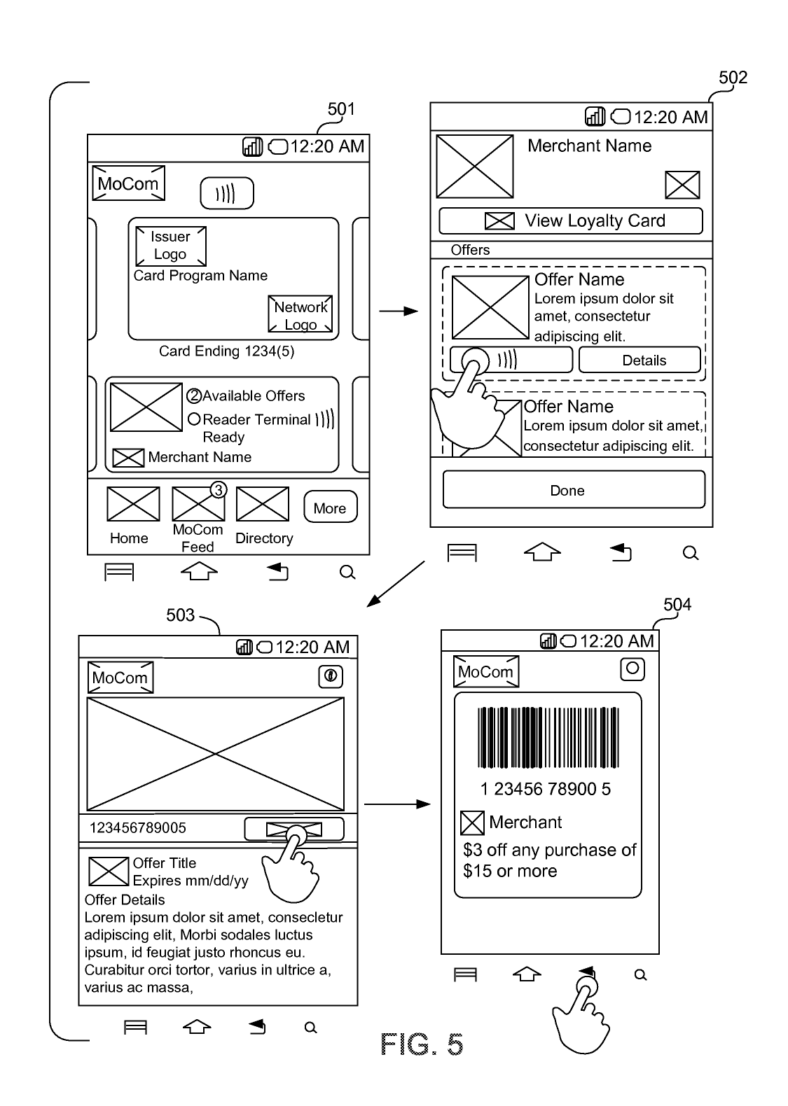

In step 401, the consumer begins at a “home” screen on a mobile phone. For example, referring to FIG. 5, view 501 shows an example of a home screen which might be displayed on the consumer's mobile phone display. In that regard, while this example refers to a mobile phone, it should be understood that the display could be provided on other devices such as, for example, a personal computer, a digital tablet, or a laptop, among many others.

As shown in view 501, a home screen depicts a feed from the MoCom platform. A series of cards (e.g., a loyalty card) is displayed for each partner, and the consumer can “swipe” to move through the cards to view different partners who might be providing offers. The card for a particular partner can include, for example, a logo of the issuer of the card (typically the partner), along with a logo of a corresponding network. Meanwhile, available offers and corresponding merchant/partner names (which may be different than the name of the loyalty card) are displayed beneath the card, along with indications showing whether there are available offers for the partner, and whether the offers are “reader terminal redemption” ready, as described more fully below. The offers may also be “swiped” through separately from the loyalty cards, and the display of offers can be independent of the display of loyalty cards.

Returning to FIG. 4, if the consumer selects an offer by, for example, touching or otherwise selecting the envelope next to “Available Offers” in view 501, then the process proceeds to step 402, where the consumer is provided with a more detailed view of the offers for that merchant, as shown in view 502. In particular, as can be seen from view 502, the name of the merchant is still displayed, but the consumer is now provided with details and a selection button for different offers, such as the names of the offers for that merchant.

If the consumer then selects a particular offer (e.g., by touching the offer in view 502 and then pressing “Done”), the process proceeds to step 403, where there is a determination of whether the consumer has already selected a maximum number of offers. In that regard, there might be, for example, a limit on how many offers a consumer can redeem for a particular partner/merchant, particularly at the same time. For example, merchants often may desire that a promotion is not combinable with any other discounts or offers. If the maximum number of offers has already been selected, the process proceeds back to step 402, where the consumer is again displayed the selected offers (and has an opportunity to de-select).

On the other hand, if the consumer has not yet reached the maximum number of offers, the process proceeds to step 405, where the selected offer is displayed in more detail. For example, as shown in view 503 in FIG. 5, a specific offer is displayed along with details of the offer, an expiration date of the offer, and the like.

In some instances, the offer can be redeemed by tapping the consumer's mobile device at or near a reader terminal, as described more fully below. In other examples, the offer can be displayed as a barcode which can be scanned by a merchant or other seller. For example, a clerk at a retail outlet could scan the barcode. If the consumer taps to redeem, the process proceeds to a post-tap summary in step 406, in which details of the redeemed offer are displayed before returning the consumer back to step 401. If the consumer chooses instead to show the barcode, the process of FIG. 4 proceeds to step 410 where the consumer's mobile device may, for example, display a screen similar to view 504, in which a barcode for the offer is displayed along with text indicating some details of the offer.

In FIG. 4, if no offers are selected in step 401, the process proceeds to step 407, where the consumer is presented with a screen without any selected offers. In some examples, the consumer may then decide to choose a show only merchant mode in step 408, in which the consumer is provided with a list of merchants. The consumer can then select a particular merchant and corresponding offers in steps 408 and 409, and redeem the offer by, for example, displaying the barcode in step 410 as described above.

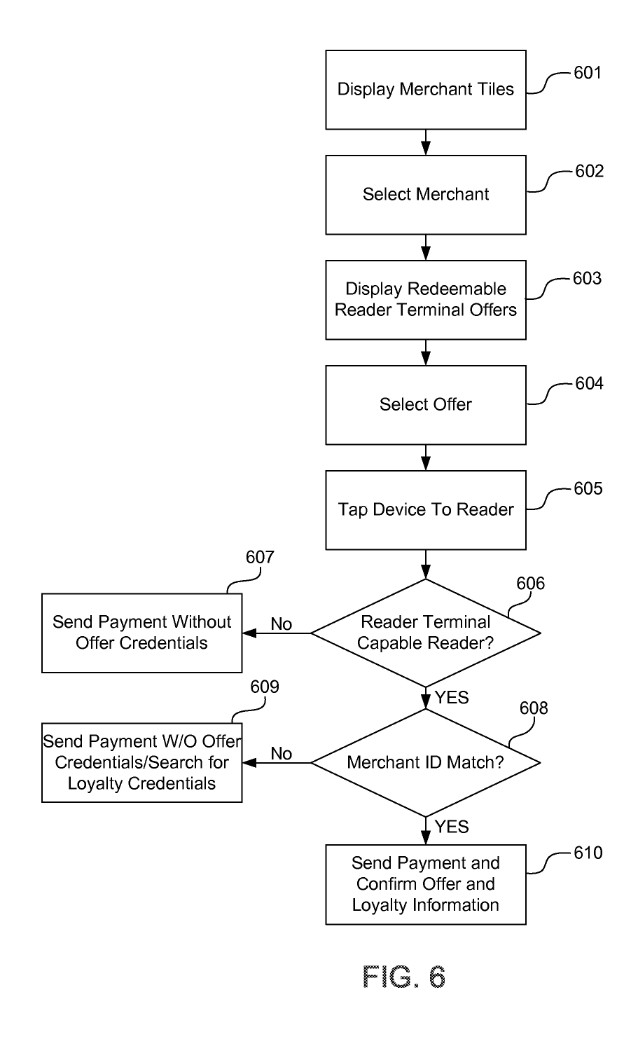

FIG. 6 is a flowchart diagram illustrating an exemplary procedure for redeeming an offer. Specifically, FIG. 6 is a flowchart for explaining a redemption system in which a consumer can simply tap or move a mobile device or other consumer device to or near a reader terminal at, for example, a merchant location, in order to redeem a corresponding offer (hereafter referred to as “reader terminal offers”). The reader terminal may implement a protocol in accordance with exemplary embodiments described in U.S. application Ser. Nos. 13/901,134 and 13/901,188, both filed on May 23, 2013 and both entitled “Systems, Methods and Computer Program Products for Providing a Contactless Protocol”, and incorporated herein by reference in their entirety.

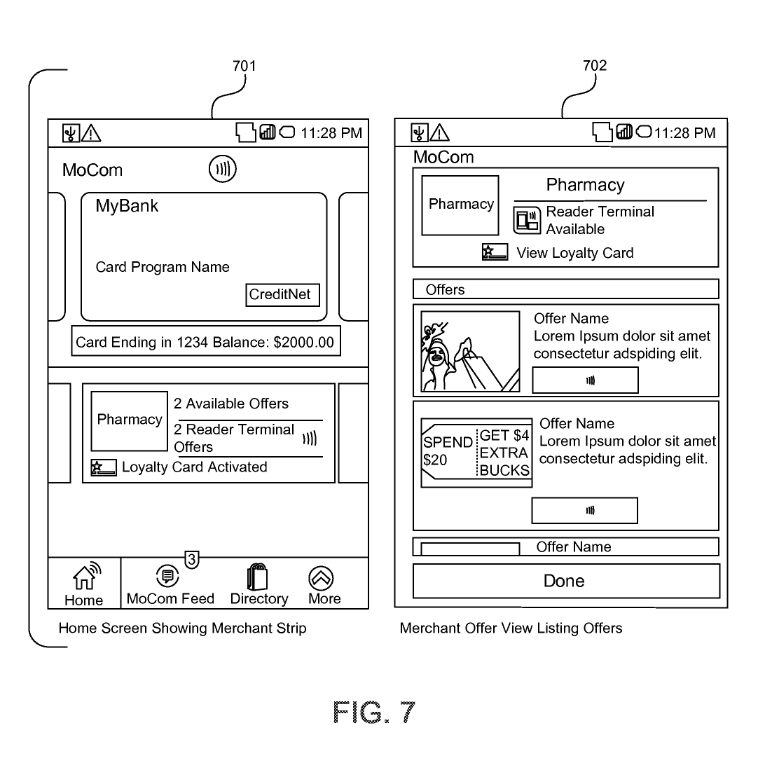

In this example embodiment, in step 601, merchant tiles are displayed. The merchant tiles are images corresponding to each merchant. FIG. 7 shows an example of such merchant tiles in view 701. In particular, as shown in view 701, a “Pharmacy” tile for a merchant is displayed, in a strip of merchant tiles from which a consumer can select. Thus, for example, the consumer may swipe through the tiles, left and right, to find a merchant. There is a tile present for every merchant that has a redeemable offer. As shown in view 701, the merchant tile for “Pharmacy” also indicates the total number of available offers, the number of reader terminal offers, and whether a loyalty card has been activated for the corresponding merchant. View 701 also shows other information for the consumer including, for example, a bank card program and a balance for the card.

In step 602, the consumer selects a merchant. For example, the user may tap the tile in order to open the merchant offer view. Generally, the user will select a merchant and offers prior to making a transaction, even if immediately prior, e.g., while waiting in line or while browsing in the store.

In step 603, reader terminal offers are displayed. In particular, as shown in FIG. 7, view 702, a merchant offer view lists offers for a particular merchant. Of course, offers which are not redeemable by tap at a reader terminal may also be displayed in the merchant offer view. If the selected merchant is not a reader terminal merchant, an option to load offers for reader terminal redemption may not be presented. If the merchant is a reader terminal redemption merchant (as shown for the “Pharmacy” in view 702, the reader terminal redemption logo is shown and the listed offers feature a button to load. In that regard, individual stores may or may not support reader terminal offers, and may, for example, display a reader terminal logo at the point of sale to indicate compatibility.

The merchant offer view 702 restricts the view to redeemable offers only—that is, non-redeemable promotions ore expired offers are not shown. If present, a loyalty card may also be noted, as shown in view 702.

In step 604, a user selects an offer. For example, referring to view 702, the user can select a reader terminal offer by tapping the corresponding reader terminal button for a displayed offer, and then hitting the “Done” bar at the bottom of the screen. The “Done” bar is a trigger to load the select offers into a secure storage element on the consumer's device (e.g., secure element 112). In some embodiments, if space is limited in the storage element, offers from another merchant may be removed at the same time new offers are loaded, thus saving space and ensuring that there are only offers from one merchant present in the storage element at any given time.

In step 605, the consumer taps the user's device to the reader, or moves it within a particular close distance of the reader. In particular, in one example, the user taps his/her mobile phone to a reader at a point of sale. Of course, other environments are possible.

In step 606, there is a determination of whether the reader is capable of using the reader terminal redemption system. For example, a point of sale reader at a merchant location may be compatible with tapping the phone for payment, but not specifically compatible with the reader terminal offer system. In other words, a payment application may be active, but the reader terminal offer system may not be.

In step 607, if the reader tapped is not a compatible with the reader terminal system, the selected payment card is sent, but no offers or loyalty credentials are sent. The user sees a post-tap message indicating that payment credentials were sent, with no other information. Tap time will be short (under 500 milliseconds typically) as only payment applets are active.

Meanwhile, if the reader tapped is reader terminal redemption capable, there is a determination of whether the merchant ID for the selected offer matches the selected merchant. In particular, the first step in a reader terminal system is for the point of sale reader to send the “merchant ID” to a reader terminal applet (or other process) on the user device. The applet receives the merchant ID and compares it to the selected merchant ID. For example, there is a determination of whether the user at a pharmacy has actually selected the corresponding offer for the pharmacy.

In step 609, if the reader tapped is a reader terminal capable reader, but the merchant-ID does not match the selected merchant, offers will not be sent. The reader terminal redemption applet in the secure element will still look for a loyalty card for this merchant-ID, and will transmit loyalty credentials if present. The user sees a post-tap message indicating that a reader terminal transaction took place, identifying the merchant and reporting that loyalty credentials were sent (if they were available) as well as the payment credentials. Tap time may be the longest in this scenario—potentially over one second.

On the other hand, if the tapped reader is reader terminal capable and the merchant ID for the offer matches the selected merchant, the process proceeds to step 610, where selected offers and (if present) the loyalty card for the merchant will be sent. The user sees a post-tap message confirming the merchant, confirming that offers and loyalty (if present) were sent, along with payments. Tap time is probably slightly under one second in this scenario. Thus, in the foregoing example, the consumer device is a mobile device, and wherein the consumer redeems the offer during a corresponding transaction by moving the mobile device near a reader at the transaction location.

Following the tap, the offers that were loaded into the storage element are left in the storage element until the consumer removes them or selects offers from another merchant. Alternatively, if the offers expire, they can be removed from the storage element by a maintenance application running on the MoCom platform. The selected merchant will remain the “active” merchant on the consumer's home page until the user selects a different merchant.

In some aspects, space on the consumer's storage element (e.g., a non-volatile memory on the user's mobile phone) may be limited. Accordingly, it is ordinarily helpful to conserve space on the storage element by, for example, (i) loading offers into the storage element, (ii) unloading offers out of the storage element to make room for others and (iii) helping the user avoid exhausting the available space unintentionally. In addition, the process of writing the offers to the storage element may take time. As such, it is ordinarily useful to notify a user (and allow a user to control) storage element transactions such as loading offers, so that the user is not frustrated by, for example, blocking activity by the MoCom platform during the process of loading the offers. In addition, once the merchant ID is matched, the reader terminal applet must build a package of data for the point of sale (essentially a buffer or set of buffers including offers and loyalty data). Time can be saved by pre-building the buffer, but this uses some memory space in the secure storage element.

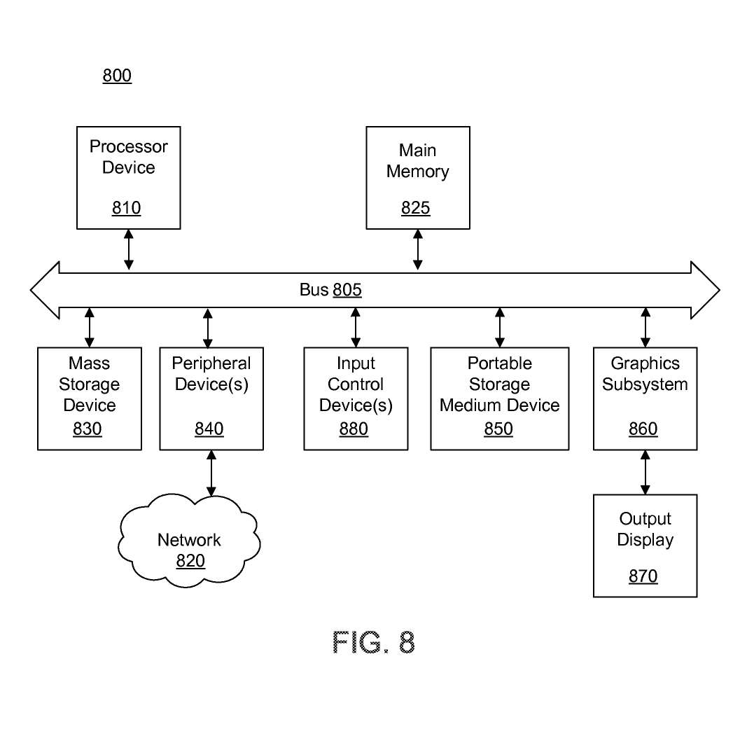

FIG. 8 is a block diagram of a general and/or special purpose computer 800, which may be a general and/or special purpose computing device, in accordance with some of the example embodiments of the invention. The computer 800 may be, for example, a consumer device, a consumer computer, a client computer and/or a server computer, among other things.

The computer 800 may include without limitation a processor device 810, a main memory 825, and an interconnect bus 805. The processor device 810 may include without limitation a single microprocessor, or may include a plurality of microprocessors for configuring the computer 800 as a multi-processor system. The main memory 825 stores, among other things, instructions and/or data for execution by the processor device 810. The main memory 825 may include banks of dynamic random access memory (DRAM), as well as cache memory.

The computer 800 may further include a mass storage device 830, peripheral device(s) 840, portable non-transitory storage medium device(s) 850, input control device(s) 880, a graphics subsystem 860, and/or an output display interface 870. For explanatory purposes, all components in the computer 800 are shown in FIG. 8 as being coupled via the bus 805. However, the computer 800 is not so limited. Devices of the computer 800 may be coupled via one or more data transport means. For example, the processor device 810 and/or the main memory 825 may be coupled via a local microprocessor bus. The mass storage device 830, peripheral device(s) 840, portable storage medium device(s) 850, and/or graphics subsystem 860 may be coupled via one or more input/output (I/O) buses. The mass storage device 830 may be a nonvolatile storage device for storing data and/or instructions for use by the processor device 810. The mass storage device 830 may be implemented, for example, with a magnetic disk drive or an optical disk drive. In a software embodiment, the mass storage device 830 is configured for loading contents of the mass storage device 830 into the main memory 825.

The portable storage medium device 850 operates in conjunction with a nonvolatile portable storage medium, such as, for example, a compact disc read only memory (CD-ROM), to input and output data and code to and from the computer 800. In some embodiments, the software for storing information may be stored on a portable storage medium, and may be inputted into the computer 800 via the portable storage medium device 850. The peripheral device(s) 840 may include any type of computer support device, such as, for example, an input/output (I/O) interface configured to add additional functionality to the computer 800. For example, the peripheral device(s) 840 may include a network interface card for interfacing the computer 800 with a network 820.

The input control device(s) 880 provide a portion of the consumer interface for a consumer of the computer 800. The input control device(s) 880 may include a keypad and/or a cursor control device. The keypad may be configured for inputting alphanumeric characters and/or other key information. The cursor control device may include, for example, a handheld controller or mouse, a trackball, a stylus, and/or cursor direction keys. In order to display textual and graphical information, the computer 800 may include the graphics subsystem 860 and the output display 870. The output display 870 may include a cathode ray tube (CRT) display and/or a liquid crystal display (LCD). The graphics subsystem 860 receives textual and graphical information, and processes the information for output to the output display 870.

Each component of the computer 800 may represent a broad category of a computer component of a general and/or special purpose computer. Components of the computer 800 are not limited to the specific implementations provided here.

The example embodiments of the invention may be implemented using hardware, software or a combination thereof and may be implemented in one or more computer systems or other processing systems. However, the manipulations performed by these example embodiments were often referred to in terms, such as entering, which are commonly associated with mental operations performed by a human operator. No such capability of a human operator is necessary, in any of the operations described herein. Rather, the operations may be completely implemented with machine operations. Useful machines for performing the operation of the example embodiments presented herein include general purpose digital computers or similar devices.

From a hardware standpoint, a processor device 810 typically includes one or more components, such as one or more microprocessors, for performing the arithmetic and/or logical operations required for program execution, and storage media, such as one or more disk drives or memory cards (e.g., flash memory) for program and data storage, and a random access memory, for temporary data and program instruction storage. From a software standpoint, a processor device 810 typically includes software resident on a storage media (e.g., a disk drive or memory card), which, when executed, directs the processor device 810 in performing transmission and reception functions. The processor device software may run on an operating system stored on the storage media, such as, for example, UNIX or Windows (e.g., NT, XP, Vista), Linux, and the like, and can adhere to various protocols such as the Ethernet, ATM, TCP/IP protocols and/or other connection or connectionless protocols. As is well known in the art, CPUs can run different operating systems, and can contain different types of software, each type devoted to a different function, such as handling and managing data/information from a particular source, or transforming data/information from one format into another format. It should thus be clear that the embodiments described herein are not to be construed as being limited for use with any particular type of server computer, and that any other suitable type of device for facilitating the exchange and storage of information may be employed instead.

Although for convenience processor device 810 is shown as being a single CPU, in other example embodiments processor device 810 may include plural separate CPUs, wherein each is dedicated to a separate application, such as, for example, a data application, a voice application, and a video application.

Software embodiments of the example embodiments presented herein may be provided as a computer program product, or software, that may include an article of manufacture on a machine accessible or machine readable medium having instructions. The instructions on the machine accessible or machine readable medium may be used to program a computer system or other electronic device. The machine-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

While various example embodiments of the present invention have been described above, it should be understood that they have been presented by way of example, and not limitation. It will be apparent to persons skilled in the relevant art(s) that various changes in form and detail can be made therein. Thus, the present invention should not be limited by any of the above described example embodiments, but should be defined only in accordance with the following claims and their equivalents.

In addition, it should be understood that the FIGS. 1-8 are presented for exemplary purposes only. The architecture of the example embodiments presented herein is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A system for managing service provider offers, comprising:
a processor configured to:
generate an offer associated with a service provider, wherein the offer includes attributes defining the offer;
select a campaign to pair the offer to, wherein the campaign includes criteria for receiving the offer;
deliver the offer to a mobile device associated with a consumer matching the campaign criteria; and
enable rendering of the offer at the mobile device.

2. The system according to claim 1, wherein a determination of whether the consumer matches the campaign criteria is made by comparing the campaign criteria against profile information of the consumer.

3. The system according to claim 2, wherein the campaign criteria include a location or whether the consumer has a loyalty card for the service provider.

4. The system according to claim 2, wherein the campaign criteria include whether the consumer has previously indicated a preference for the service provider.

5. The system according to claim 1, wherein the offer expires after a predetermined period of time.

6. The system according to claim 1, wherein the system stores a directory of service providers, and wherein a display of the service providers is provided at the mobile device to enable applying the offer to an existing transaction.

7. The system according to claim 1, wherein the consumer redeems the offer during a corresponding transaction by moving the mobile device near a reader at the transaction location.

8. The system according to claim 1, wherein the consumer submits profile information to access to the system, and wherein the system delivers offers from service providers corresponding to the submitted profile information.

9. The system according to claim 1, wherein the system provides an application program interface (API) by which the service provider enters attributes of the offer and pairs the offer to the campaign.

10. A method for managing service provider offers, comprising:
generating an offer associated with a service provider, wherein the offer includes attributes defining the offer;
selecting a campaign to pair the offer to, wherein the campaign includes criteria for receiving the offer;
delivering the offer to a mobile device associated with a consumer matching the campaign criteria; and
enabling rendering of the offer at the mobile device.

11. The method according to claim 10, wherein a determination of whether the consumer matches the campaign criteria is made by comparing the campaign criteria against profile information of the consumer.

12. The method according to claim 11, wherein the campaign criteria include a location or whether the consumer has a loyalty card for the service provider.

13. The method according to claim 11, wherein the campaign criteria include whether the consumer has previously indicated a preference for the service provider.

14. The method according to claim 10, wherein the offer expires after a predetermined period of time.

15. The method according to claim 10, wherein the system stores a directory of service providers, and wherein a display of the service providers is provided at the mobile device to enable applying the offer to an existing transaction.

16. The method according to claim 10, wherein the consumer redeems the offer during a corresponding transaction by moving the mobile device near a reader at the transaction location.

17. The method according to claim 10, wherein the consumer submits profile information to access to the system, and wherein the system delivers offers from service providers corresponding to the submitted profile information.

18. The method according to claim 10, wherein an application program interface (API) is provided by which the service provider enters attributes of the offer and pairs the offer to the campaign.

19. A non-transitory computer-readable medium having stored thereon sequences of instructions, the sequences of instructions including instructions which when executed by a computer system causes the computer system to perform:
generating an offer associated with a service provider, wherein the offer includes attributes defining the offer;
selecting a campaign to pair the offer to, wherein the campaign includes criteria for receiving the offer;
delivering the offer to a mobile device associated with a consumer matching the campaign criteria; and
enabling rendering of the offer at the mobile device.

20. The computer-readable medium according to claim 19, wherein a determination of whether the consumer matches the campaign criteria is made by comparing the campaign criteria against profile information of the consumer.
